(19) United States
(12) Patent Application Publication
(10) Pub. No.: US 2021/0301227 A1
(43) Pub. Date: Sep. 30, 2021

(54) LAUNDRY ARTICLE

(71) Applicant: Marina Safran-Kanopkin, Las Vegas, NV (US)

(72) Inventor: Marina Safran-Kanopkin, Las Vegas, NV (US)

(21) Appl. No.: 16/828,735

(22) Filed: Mar. 24, 2020

(51) Int. Cl. C11D 17/04; C11D 17/06

(52) U.S. Cl. CPC C11D 17/044; C11D 1/16; C11D 17/06

(57) ABSTRACT

A laundry article has a water soluble substrate that has a first predefined region on a first side and a second predefined region on a second side. The at least one of the first predefined region and the second predefined region is coated a detergent coating.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to a laundry article. More so, the present invention relates to a detergent strips to be used in washing machine.

### Description of the Related Art

Typically a laundry detergent is added to a washing machine with the soiled clothing and water for the washing step, followed by adding a fabric softener or conditioner. The laundry detergent can be powdered, liquid or in form of a tablet. One way to provide for both the cleaning and conditioning of fabrics from a single product is to have a laundry detergent with fabric softener built into the liquid or powdered composition. In other examples, U.S. Pat. No. 4,170,565 describes an article of manufacture comprising a water-insoluble substrate impregnated with detergents and fabric conditioners that is useful in a process for cleaning fabrics. Also, detergent strips are known, however, these detergent strips is made of non water-soluble material that either leaves particles or fabric in the washed cloths.

There is a need of detergent strips that solves the above limitations.

### BRIEF SUMMARY OF THE INVENTION

A primary object of the disclosure is to provide a laundry article.

Another object of the present disclosure is a laundry article that has detergent and conditioner.

Yet another object of the present disclosure is to provide a laundry article in form of strips that have detergent and conditioner.

### DESCRIPTION OF THE DRAWINGS

Having thus described the disclosure in general terms, reference will now be made to the accompanying figure, wherein:

FIG. 1 illustrates a top view of the water soluble substrate 100, in accordance with an embodiment of the present disclosure.

FIG. 2 illustrates the bottom view of the water soluble substrate 100, in accordance with an embodiment of the present disclosure.

FIG. 3 illustrates the water soluble substrate 100, in accordance with an embodiment of the present disclosure.

It should be noted that the accompanying figure are intended to present illustrations of exemplary embodiments of the present disclosure. This figure is not intended to limit the scope of the present disclosure. It should also be noted that accompanying figure is not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figure is intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

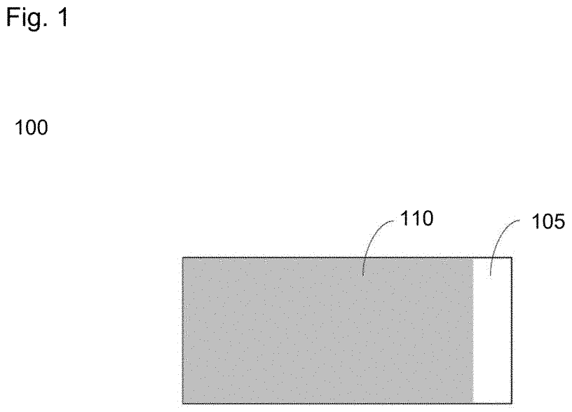

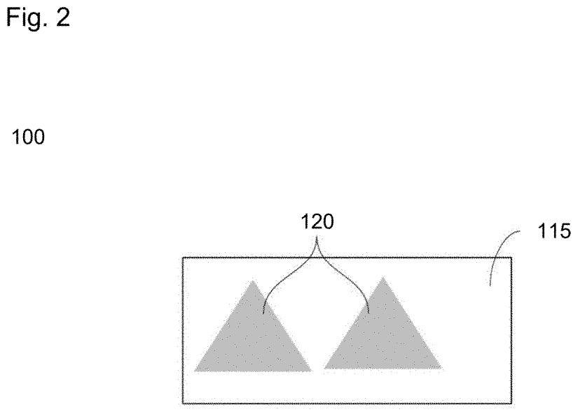

FIG. 1 illustrates a top view of a water soluble substrate 100, in accordance with an embodiment of the present disclosure. The water soluble substrate 100 has a first side 105 and a second side. The second side is described in conjunction with FIG. 2. The first side 105 has a first predefined region 110 and the second side has a second predefined region respectively. At least one of the first predefined region 110 and the second predefined region has a detergent coating. In an embodiment of the present invention, the detergent coating on one or more of the first predefined region 110 and the second predefined region has one or more of poly vinyl alcohol, 1-dodecanol, fatty alcohol poly glycol ether and parfum. In an embodiment of the present invention, the first predefined region 110 and the second predefined region have different surface areas. In an embodiment of the present invention, the area of the water soluble substrate 100 is less than 30 mm square. In an embodiment of the present disclosure, the water suable substrate 100 has a predefined thickness less than 1 mm. In another embodiment of the present disclosure, the water soluble substrate 100 is made of non-woven fiber joined by a water soluble adhesive, such that the water soluble substrate 100 disintegrates or dissolves in water.

FIG. 2 illustrates a bottom view of the water soluble substrate 100, in accordance with an embodiment of the present disclosure. A second side 115 of the water soluble substrate 100 has a second predefined region 120. In an embodiment of the present disclosure, the first predefined region 110 is defined by a first shape and the second predefined region 120 is defined by a second shape. For example, the first predefined region 110 is shown to be a rectangle and the second predefined region 120 is shown to be a triangle. It should be noted that the shapes are shown for explanation purpose and does not intend to limit the scope of the disclosure. In an embodiment of the present invention, the first predefined region 110 has a first area coated with a detergent and the second predefined region 120 has a second area coated with a conditioner. The areas, quality and adhesion of detergent and the conditioner is such that the conditioner survives the washing cycle.

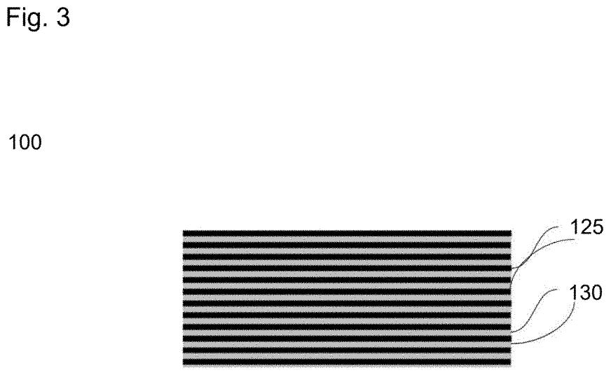

FIG. 3 illustrates the water soluble substrate 100, in accordance with an embodiment of the present disclosure. The water soluble substrate 100 has non-woven fibers 125 joined by water soluble adhesive 130.

Accordingly, while only a few embodiments of the present invention have been shown and described, it is obvious that many changes and modifications may be made without departing from the spirit and scope of the invention.

What is claimed is:

1. A laundry article comprising a water soluble substrate, wherein the water suable substrate is defined by a first side and a second side, wherein the first side and the second side are defined by a first predefined region and a second predefined region respectively, wherein the first predefined region and the second predefined region have different surface area, wherein one or more of the first predefined region and the second predefined region has a detergent coating.

2. The laundry article of claim 1, wherein the detergent coating has one or more of poly vinyl alcohol, 1-dodecanol, fatty alcohol poly glycol ether and parfum.

3. The laundry article of claim 1, wherein the water soluble substrate is defined by a predefined thickness, wherein the predefined thickness is less than 1 mm.

4. The laundry article of claim 1, wherein the water soluble substrate is made of non-woven fiber joined by a water soluble adhesive.

5. The laundry article of claim 1, wherein the water soluble substrate disintegrates in water.

6. The laundry article of claim 1, wherein the first predefined region is defined by a first concentration and the second predefined region is defined by a second concentration.

7. The laundry article of claim 1, wherein the first predefined region is defined by a first shape and the second predefined region is defined by a second shape.

8. The laundry article of claim 1, wherein the water soluble substrate has a predefined area, wherein the predefined area is less than 30 mm square.

9. A laundry article comprising a water soluble substrate, wherein the water soluble substrate is made of non-woven fiber joined by a water soluble adhesive, wherein the water soluble substrate is defined by a first side and a second side, wherein the first side and the second side are defined by a first predefined region and a second predefined region respectively, wherein the first predefined region is defined by a first shape and the second predefined region is defined by a second shape, wherein at least one of the first predefined region and the second predefined region is coated with a detergent coating, wherein the first predefined region is defined by a first concentration and the second predefined region is defined by a second concentration.

10. The laundry article of claim 10, wherein the detergent coating has one or more of poly vinyl alcohol, 1-dodecanol, fatty alcohol poly glycol ether and parfum.

11. The laundry article of claim 10, wherein the water soluble substrate is defined by a predefined thickness, wherein the predefined thickness is less than 1 mm.

12. The laundry article of claim 10, wherein the water soluble substrate disintegrates in water.

13. The laundry article of claim 10, wherein the first predefined region is defined by a first area and the second predefined region is defined by a second area.

14. The laundry article of claim 10, wherein the water soluble substrate has a predefined area, wherein the predefined area is less than 30 mm square.
